(19) United States
(12) Patent Application Publication
(10) Pub. No.: US 2026/0302441 A1
(43) Pub. Date: Oct. 1, 2026

(54) ALL-SOLID-STATE BATTERY AND METHOD FOR MANUFACTURING THE SAME

(71) Applicant: HONDA MOTOR CO., LTD., Tokyo (JP)

(72) Inventor: Hideaki SASAKI, Saitama (JP)

(21) Appl. No.: 19/630,481

(22) Filed: Mar. 27, 2026

(30) Foreign Application Priority Data
Mar. 31, 2025 (JP) 2025-060176

(51) Int. Cl. H01M 50/129; H01M 10/0585; H01M 50/105; H01M 50/119; H01M 50/121; H01M 50/46

(52) U.S. Cl. CPC H01M 50/129; H01M 10/0585; H01M 50/105; H01M 50/119; H01M 50/121; H01M 50/46

(57) ABSTRACT

An all-solid-state battery according to an embodiment of the invention includes an outer casing, and an electrode laminate housed inside the outer casing. The electrode laminate includes a positive electrode layer, a negative electrode layer, and a solid electrolyte layer disposed between the positive electrode layer and the negative electrode layer. The outer casing has an internal pressure within a range of 10 kPa or more and 20 kPa or less.

This application is based on and claims the benefit of priority from Japanese Patent Application No. 2025-060176, filed on 31 Mar. 2025, the content of which is incorporated herein by reference.

### BACKGROUND OF THE INVENTION

### Field of the Invention

The present invention relates to an all-solid-state battery and a method for manufacturing the same.

### Related Art

In recent years, research and development has been conducted on secondary batteries that contribute to energy efficiency in order to ensure that more people have access to affordable, reliable, sustainable, and advanced energy. Among secondary batteries, an all-solid-state battery is attracting attention because it has a higher energy density, a higher chemical stability, and a longer life span than a battery including a liquid electrolyte.

An all-solid-state battery generally includes an electrode laminate including a positive electrode layer, a negative electrode layer, and a solid electrolyte layer disposed between the positive electrode layer and the negative electrode layer. The electrode laminate is housed in an outer casing. As the outer casing, a laminate film is used. The internal pressure of the outer casing is generally lower than the external pressure applied to the outer casing (Patent Document 1).
Patent Document 1: PCT International Publication No. WO2022/154112

### SUMMARY OF THE INVENTION

In the technology related to secondary batteries, the improvement of high-rate characteristics and the increase in capacity are issues to be addressed. In order to improve the high-rate characteristics and increase the capacity of all-solid-state batteries, it has been studied to reduce the thickness of the electrodes of the electrode laminate to facilitate the movement of the charge transfer medium, and to stack a plurality of such electrode laminates. However, according to the study of the present inventors, when a plurality of electrode laminates are housed in an outer casing, the electrode laminates may become misaligned inside the outer casing, causing concentrated surface pressure exceeding atmospheric pressure to be applied to the end portions of the outer casing, which may result in cracks occurring at the end portions of the electrode laminates. Additionally, in a manufacturing factory of an all-solid-state battery, a produced all-solid-state battery may be conveyed to a predetermined position by suction conveyance. In an outer casing including a laminate film, air remains inside the outer casing and wrinkles easily occur, and when wrinkles occur in the outer casing, the all-solid-state battery may not be conveyed by suction conveyance.

The present invention has been made in view of the above issues, and an object of the present invention is to provide an all-solid-state battery and a method for manufacturing the all-solid-state battery in which even when a plurality of electrode laminates are housed in an outer casing, the electrode laminates are less likely to be misaligned, and in which wrinkles in the outer casing, which are a concern during suction conveyance, are less likely to occur. This contributes to energy efficiency.

The present inventors have found that adjusting the internal pressure of the outer casing within a predetermined range is effective for addressing the above issues, and have completed the present invention. Accordingly, the present invention provides the following.

A first aspect of the present invention is an all-solid-state battery including an outer casing, and an electrode laminate housed inside the outer casing. The electrode laminate includes a positive electrode layer, a negative electrode layer, and a solid electrolyte layer disposed between the positive electrode layer and the negative electrode layer. The outer casing has an internal pressure within a range of 10 kPa or more and 20 kPa or less.

According to the all-solid-state battery of the first aspect, since the internal pressure of the outer casing is within the above range, even when a plurality of electrode laminates are housed in the outer casing, the electrode laminates are less likely to be misaligned. Further, if there are wrinkles that affect suction before suction conveyance, the suction conveyance may not be possible. According to the all-solid-state battery of the first aspect, since the internal pressure of the outer casing is within the above range and the internal pressure is appropriately adjusted, wrinkles due to sticking of the laminate film on the surface of the cell when the vacuum pressure is set, which is a problem during suction conveyance, do not occur. Therefore, the all-solid-state battery of the first aspect can be conveyed by suction conveyance.

In a second aspect of the present invention according to the first aspect, the outer casing includes a laminate film. The laminate film includes a metal layer, an inner resin layer disposed on an inner side of the metal layer, and an outer resin layer disposed on an outer side of the metal layer. The metal layer has a thickness within a range of 2 times or more and 3 times or less a thickness of the inner resin layer.

According to the all-solid-state battery of the second aspect, since the thickness of the metal layer of the laminate film included in the outer casing is large and the thermal conductivity is high, an increase in the temperature of the electrode laminate can be prevented, and the battery characteristics are improved.

In a third aspect of the present invention according to the first or second aspect, a thickness of the negative electrode layer varies due to charging and discharging. The outer casing includes a bent portion that can expand and contract in a stacking direction of the electrode laminate in accordance with a change in the thickness of the negative electrode layer.

According to the all-solid-state battery of the third aspect, since the outer casing includes the bent portion that can expand and contract in a stacking direction of the electrode laminate in accordance with a change in the thickness of the negative electrode layer of the electrode laminate, it is possible to suppress the application of an excessive pressure to the electrode laminate, and further, the electrode laminates are less likely to be misaligned.

In a fourth aspect of the present invention according to any one of the first to third aspects, two or more of the electrode laminates are stacked inside the outer casing.

According to the all-solid-state battery according to the fourth aspect, since two or more of the electrode laminates are included, the electric capacity increases.

In a fifth aspect of the present invention according to any one of the first to fourth aspects, a resin coat is provided on at least a part of a surface of the electrode laminate facing the outer casing.

According to the all-solid-state battery of the fifth aspect, since the electrode laminate is protected by the resin coat, the electrode laminate is less likely to be damaged by an impact from the outside. Additionally, the electrode laminate is less likely to be damaged during the manufacture of the all-solid-state battery.

A sixth aspect of the present invention is a method for manufacturing an all-solid-state battery. The method includes: housing an electrode laminate including a positive electrode layer, a negative electrode layer, and a solid electrolyte layer disposed between the positive electrode layer and the negative electrode layer, in an outer container having an opening; reducing an internal pressure of the outer container to degas an interior thereof through the opening thereof until the internal pressure thereof falls within a range of 10 kPa or more and 20 kPa or less; and sealing the opening thereof to obtain an all-solid-state battery.

According to the all-solid-state battery of the sixth aspect, an all-solid-state battery in which the internal pressure of the outer container is within the range of 10 kPa or more and 20 kPa or less can be industrially advantageously manufactured.

In a seventh aspect of the present invention according to the sixth aspect, the method for manufacturing an all-solid-state battery according to the sixth aspect further includes conveying the all-solid-state battery to a predetermined position by suction conveyance.

According to the method for manufacturing an all-solid-state battery of the seventh aspect, since the internal pressure of the outer container of the all-solid-state battery is within the above range, a wrinkle that would affect suction does not occur before suction conveyance. Therefore, the all-solid-state battery can be conveyed by suction conveyance.

According to the present invention, even when a plurality of electrode laminates are housed in an outer casing, the internal pressure of the outer casing is low, and therefore the outer casing is pressed against the electrode laminates, acting as a fixing force for the electrode laminates, making it possible to provide an all-solid-state battery and a method for manufacturing the same in which the electrode laminates are less likely to be misaligned and are less likely to wrinkle even when conveyed by suction conveyance.

### BRIEF DESCRIPTION OF THE DRAWINGS

FIG. 1 is a side view of an all-solid-state battery according to an embodiment of the present invention;

FIG. 2 is a plan view of the all-solid-state battery according to the embodiment of the present invention;

FIG. 3 is a cross-sectional view taken along line III-III in FIG. 2;

FIG. 4 is a cross-sectional view taken along line IV-IV in FIG. 2; and

FIG. 5 is a partial cross-sectional view of an all-solid-state battery produced in an Example.

### DETAILED DESCRIPTION OF THE INVENTION

Hereinafter, an embodiment of the present invention will be described with reference to the drawings. However, the following embodiment exemplifies the present invention, and the present invention is not limited to the following embodiment.

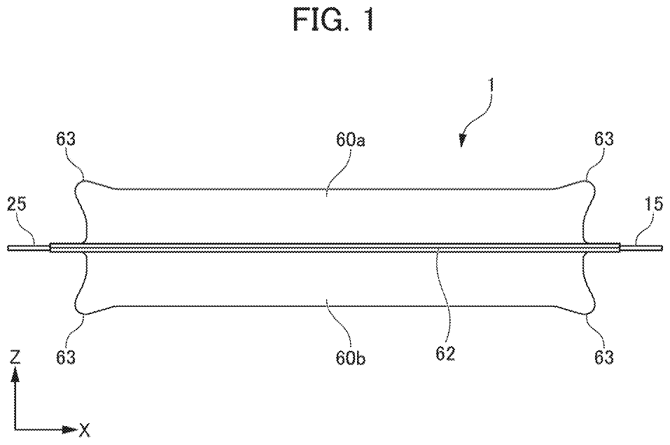

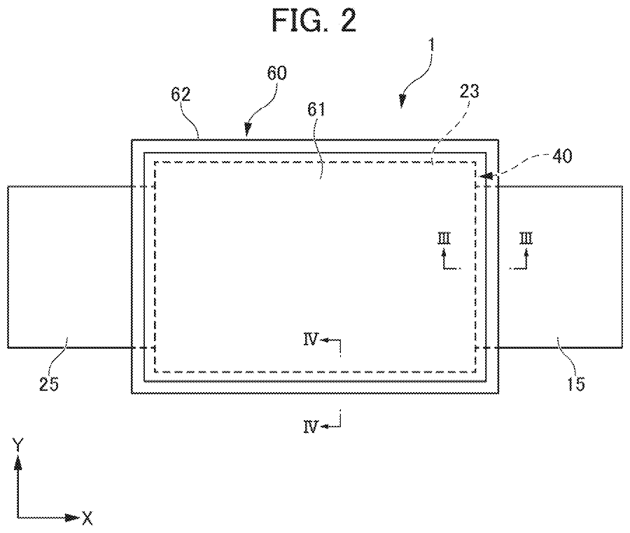

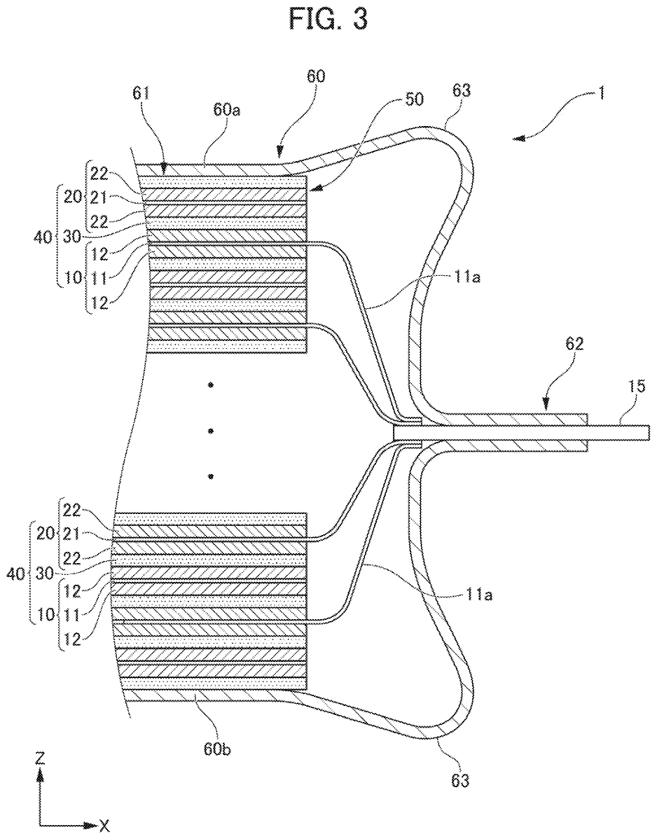

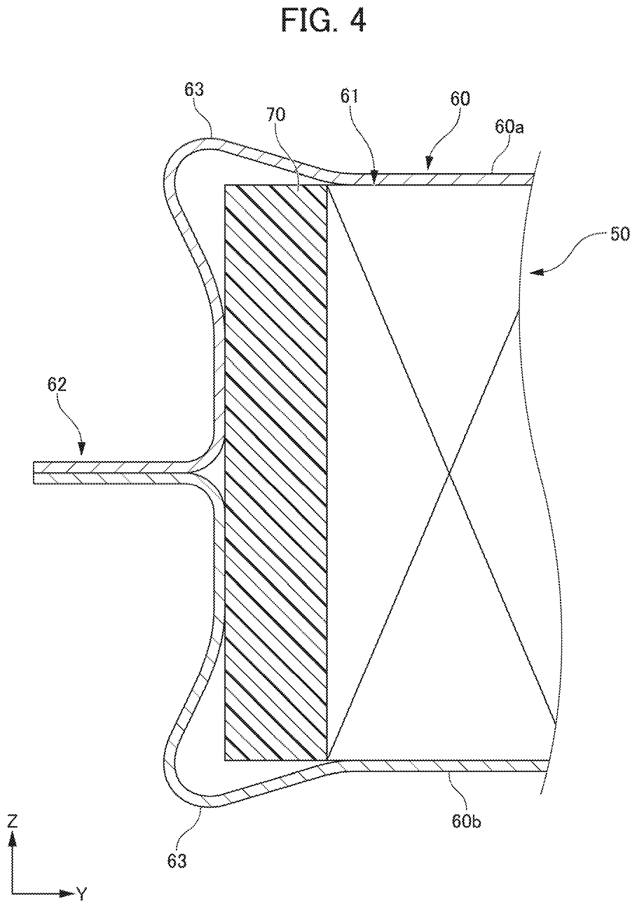

FIG. 1 is a side view showing the appearance of an all-solid-state battery according to an embodiment of the present invention. FIG. 2 is a plan view of the all-solid-state battery according to the embodiment of the present invention, FIG. 3 is a cross-sectional view taken along line III-III in FIG. 2, and FIG. 4 is a cross-sectional view taken along line IV-IV in FIG. 2.

An all-solid-state battery 1 includes an outer casing 60 and an electrode laminate 40 housed inside the outer casing 60. The size of the all-solid-state battery 1 may be, for example, 400 mm or more and 600 mm or less in length, 80 mm or more and 120 mm or less in width, and 3 mm or more and 10 mm or less in thickness.

The electrode laminate 40 includes a positive electrode layer 10, a negative electrode layer 20, and a solid electrolyte layer 30 disposed between the positive electrode layer 10 and the negative electrode layer 20. A plurality of the electrode laminates 40 are laminated to form an all-solid-state battery cell 50.

The internal pressure of the outer casing 60 is within the range of 10 kPa or more and 20 kPa or less. When the internal pressure of the outer casing 60 is within this range, the adhesion between the electrode laminate 40 and the outer casing 60 becomes good, which acts as a fixing force. Thus, the misalignment between the electrode laminates 40 and the outer casing 60 is less likely to occur, and wrinkles are less likely to form on the outer casing.

The outer casing 60 includes two laminate films 60a and 60b. The end portions of the two laminate films 60a and 60b overlap to form a housing portion 61 that houses the all-solid-state battery cell 50. The four sides of the laminate film 60a and the four sides of the laminate film 60b, which respectively oppose each other, are fused to form a sealing portion 62.

Although not shown, the laminate films 60a and 60b each include a metal layer, an inner resin layer disposed on an inner side of the metal layer, and an outer resin layer disposed on an outer side of the metal layer. As the material of the metal layer, for example, aluminum can be used. Examples of the material of the inner resin layer include polyethylene, polypropylene, ethylene-vinyl acetate copolymer, polyurethane, and polyethylene terephthalate. Examples of the material of the outer resin layer include polyimide, polyester, polycarbonate, acrylic resin, and fluorine resin.

The thickness of the metal layer of the laminate films 60a and 60b may be within the range of 2 times or more and 3 times or less the thickness of the inner resin layer. The thickness of the metal layer may be within the range of, for example, 46 μm or more and 100 μm or less. The thickness of the inner resin layer may be within the range of, for example, 23 μm or more and 35 μm or less. The thickness of the outer resin layer may be within the range of, for example, 2 μm or more and 30 μm or less.

The outer casing 60 includes bent portions 63 that can expand and contract in the stacking direction of the all-solid-state battery cell 50 to accommodate thickness changes in the negative electrode layer 20 caused by charging and discharging. The bent portions 63 are disposed along the corners of the upper and lower surfaces of the all-solid-state battery cell 50 in the stacking direction. For example, when the thickness of the negative electrode layer 20 increases due to charging, the bent portion 63 extends in the stacking direction of the all-solid-state battery cell 50, and when the thickness of the negative electrode layer 20 decreases due to discharging, the bent portion 63 bends.

A resin coat 70 is disposed between the end surface of the all-solid-state battery cell 50 on the side where a positive electrode tab 15 or a negative electrode tab 25 is not disposed and the outer casing 60. The step between stacked all-solid-state battery cells 50 is absorbed by filling the space with the resin coat 70. The resin coat 70 has a function of protecting the all-solid-state battery cell 50 from physical impact. The resin coat 70 may have a Young's modulus at 25° C. of 70 MPa or less, or 40 MPa or less. The thickness of the resin coat 70 may be within the range of 0.1 mm or more and 1.0 mm or less. As the material of the resin coat, a polyolefin resin, an acrylic resin, or a silicone resin can be used. The resin coat 70 may be disposed on the end surface on the side where the positive electrode tab 15 or the negative electrode tab 25 is not disposed.

In the all-solid-state battery 1 of the present embodiment, the configurations of the positive electrode layer 10, the negative electrode layer 20, and the solid electrolyte layer 30 included in the electrode laminate 40 are not particularly limited, and those used in a conventional all-solid-state battery can be used.

The positive electrode layer 10 includes a positive electrode current collector 11 and a positive electrode active material layer 12. The positive electrode active material layers 12 are respectively laminated on both surfaces of the positive electrode current collector 11. One end portion of the positive electrode current collector 11 serves as a positive electrode current collector extension portion 11a extending outward. The positive electrode current collector extension portion 11a is connected to the positive electrode tab 15, and the positive electrode tab 15 extends from the outer casing 60.

Examples of the material of the positive electrode current collector 11 include aluminum, an aluminum alloy, stainless steel, nickel, iron, and titanium.

As the material of the positive electrode active material layer 12, a composition containing a positive electrode active material, a conductivity aid, and a binder can be used. Examples of the positive electrode active material include lithium cobaltate (LiCoO₂), lithium nickelate (LiNiO₂), lithium nickel manganese cobalt oxide (NMC: LiNiₚMn_{q}CoᵣO₂ (p+q+r=1)), LiNiₚ Al_{q} CoᵣO₂ (p+q+r=1), lithium manganate (LiMn₂O₄), heterogenous element-substituted Li—Mn spinel represented by Li₁₊ₓMn_{2-x-y}MO₄ (x+y=2; M is at least one selected from Al, Mg, Co, Fe, Ni, or Zn), lithium titanate (an oxide containing Li and Ti), and lithium phosphate (LiMPO₄; M is at least one selected from Fe, Mn, Co, or Ni). Examples of the conductivity aid include carbon black, natural graphite, carbon fibers, and carbon nanotubes. Examples of the binder include nitrile polymers, polyester polymers, acrylic acid polymers, cellulose polymers, styrene polymers, styrene butadiene polymers, vinyl acetate polymers, urethane polymers, vinylidene fluoride polymers, and fluoroethylene polymers.

The negative electrode layer 20 includes a negative electrode current collector 21 and negative electrode active material layers 22. The negative electrode active material layers 22 are respectively laminated on both surfaces of the negative electrode current collector 21. An end portion of the negative electrode current collector 21 on the side opposite to the positive electrode current collector extension portion 11a side of the positive electrode current collector 11 serves as a negative electrode current collector extension portion (not shown) extending outward. The negative electrode current collector extension portion is connected to the negative electrode tab 25, and the negative electrode tab 25 extends from the outer casing 60.

Examples of the material of the negative electrode current collector 21 include copper, a copper alloy, nickel, and stainless steel.

The negative electrode active material layer 22 may be a layer that generates a metal layer containing lithium during charging. When the negative electrode active material layer 22 generates a metal layer containing lithium during charging, the thickness of the negative electrode layer 20 increases. As the negative electrode active material layer 22, lithium, a metal or semimetal that forms an alloy with lithium, carbon, or an oxide can be used. Examples of the metal or semimetal that forms an alloy with lithium include Mg, Si, Au, Ag, In, Ge, Sn, Pb, Al, and Zn. Instead of the negative electrode active material layer 22, the negative electrode layer 20 may be configured such that the negative electrode current collector 21 forms a metal layer containing lithium.

The solid electrolyte layer 30 includes a solid electrolyte. As the solid electrolyte, a sulfide solid electrolyte, an oxide solid electrolyte, a nitride solid electrolyte, or a halide solid electrolyte can be used. Examples of the sulfide solid electrolyte include Li₂S—P₂S₅ and Li₂S—P₂S₅—LiI. The sulfide solid electrolyte may have an argyrodite-type crystal structure. Examples of the oxide solid electrolyte include a NASICON type oxide, a garnet type oxide, and a perovskite type oxide. Examples of the NASICON type oxide include oxides containing Li, Al, Ti, P, and O (e.g., Li_{1.5}Al_{0.5}Ti_{1.5}(PO₄)₃).

Examples of the garnet type oxide include oxides containing Li, La, Zr, and O (e.g., Li₇La₃Zr₂O₁₂).

Examples of the perovskite type oxide include oxides containing Li, La, Ti, and O (e.g., LiLaTiO₃). The solid electrolyte layer 30 may include a binder. Examples of the binder are the same as those in the positive electrode active material layer 12.

The all-solid-state battery 1 can be manufactured by a method including, for example, a housing step, a reduced pressure degassing step, and a sealing step. The manufactured all-solid-state battery 1 may be conveyed to a predetermined position by a conveying step.

The housing step is a step of housing the all-solid-state battery cell 50 in an outer container having an opening. The outer container having an opening can be formed by using two laminate films 60a and 60b. For example, the all-solid-state battery cell 50 is disposed on the inner resin layer of the laminate film 60a, the laminate film 60b is placed thereon so that the inner resin layer of the laminate film 60b is disposed on the lower side of the laminate film 60b, the end portions of the laminate films 60a and 60b overlap, and three sides of the four sides of the laminate film 60a and three sides of the four sides of the laminate film 60b, which respectively oppose each other, are sealed by fusion bonding of the inner resin layers. Thus, an outer container having an opening with one side opened can be formed.

The reduced pressure degassing step is a step of reducing the internal pressure of the outer container to degas the interior thereof until the internal pressure thereof falls within the range of 10 kPa or more and 20 kPa or less through the opening of the outer container housing the all-solid-state battery cell 50. Reduced pressure degassing can be carried out, for example, by placing the outer container in a reduced-pressure chamber to remove the gas inside the outer container, or by inserting an exhaust pipe into the opening of the outer container to remove the gas inside the outer container.

The sealing step is a step of sealing the opening of the outer container. In this manner, the entire outer peripheries of the laminate films 60a and 60b are sealed, so that the outer casing 60 is formed. Thus, the all-solid-state battery 1 is obtained.

According to the all-solid-state battery 1 of the present embodiment configured as described above, since the internal pressure of the outer casing 60 is within the range of 10 kPa or more and 20 kPa or less, in the all-solid-state battery cell 50 housed in the outer casing 60, the electrode laminates 40 are less likely to be misaligned. Additionally, according to the all-solid-state battery 1 of the present embodiment, since the internal pressure of the outer casing 60 is within the above range and the internal pressure is appropriately adjusted, wrinkles due to sticking of the laminate film on the surface of the cell when the vacuum pressure is set, which becomes a problem during suction conveyance, do not occur. Therefore, the all-solid-state battery 1 of the present embodiment can be conveyed by suction conveyance.

In the all-solid-state battery 1 of the present embodiment, the outer casing 60 includes the laminate films 60a and 60b. The laminate films 60a and 60b each include a metal layer, an inner resin layer disposed on an inner side of the metal layer, and an outer resin layer disposed on an outer side of the metal layer. When the thickness of the metal layer is within the above range, the thickness of the metal layer is thick and the thermal conductivity is high, so that the temperature rise of the all-solid-state battery cell 50 can be prevented and the battery characteristics are improved.

In the all-solid-state battery 1 of the present embodiment, when the thickness of the negative electrode layer 20 varies due to charging and discharging, and the outer casing 60 includes the bent portions 63 that can expand and contract in the stacking direction of the all-solid-state battery cell 50 in accordance with the change in the thickness of the negative electrode layer 20, it is possible to suppress excessive pressure being applied to the all-solid-state battery cell 50.

In the all-solid-state battery 1 of the present embodiment, when the all-solid-state battery cell 50 in which two or more of the electrode laminates are stacked is disposed inside the outer casing 60, the electric capacity is increased.

In the all-solid-state battery 1 of the present embodiment, when the resin coat 70 is provided on at least a part of the surface of the electrode laminate 10 facing the outer casing 60, the electrode laminate 10 is less likely to be damaged by an impact from the outside. Additionally, the electrode laminate 10 is less likely to be damaged during the manufacture of the all-solid-state battery 1.

According to the method for manufacturing an all-solid-state battery of the present embodiment, in the reduced pressure degassing step, the outer container is degassed under reduced pressure until the internal pressure thereof falls within the range of 10 kPa or more and 20 kPa or less, and then the opening of the outer container is sealed in the sealing step, thereby making it possible to industrially advantageously manufacture an all-solid-state battery in which the internal pressure of the outer container is within the range of 10 kPa or more and 20 kPa or less.

In the all-solid-state battery obtained by the method for manufacturing an all-solid-state battery of the present embodiment, since the internal pressure of the outer container is within the above range, wrinkles on the surface of the outer casing 60 (laminate films 60a and 60b), which are a concern during suction conveyance, are less likely to occur.

Although the preferred embodiment of the present invention has been described above, the present invention is not limited to the above-described embodiment, and modifications or improvements within a range capable of achieving the object of the present invention are included in the present invention. For example, in the present embodiment, the positive electrode active material layers 12 are respectively disposed on both surfaces of the positive electrode current collector 11, but it is sufficient that the positive electrode active material layer 12 is disposed on the surface of the positive electrode current collector 11 on the negative electrode layer 20 side, and the positive electrode active material layer 12 may be disposed on only one surface of the positive electrode current collector 11. The negative electrode active material layers 22 are also respectively disposed on both surfaces of the negative electrode current collector 21, but it is sufficient that the negative electrode active material layer 22 is disposed on the surface of the negative electrode current collector 21 on the positive electrode layer 10 side, and the negative electrode active material layer 22 may be disposed on only one surface of the negative electrode current collector 21. In the present embodiment, the outer casing 60 is formed by overlapping two laminate films 60a and 60b and fusing the four sides of the laminate film 60a and the four sides of the laminate film 60b, which respectively oppose each other, but may be formed by bending one laminate film and fusing the three sides of the laminate film 60a and the three sides of the laminate film 60b, which respectively oppose each other.

### EXAMPLES

Next, the present invention will be described with reference to Examples. However, the present invention is not limited to these Examples.

### Example 1

### (Production of Electrode Laminate)

A positive electrode layer, a solid electrolyte layer, and a negative electrode layer were laminated, and the obtained laminate was pressed to produce an electrode laminate. Thus, a rectangular electrode laminate having a length of 400 mm or more and 600 mm or less, a width of 80 mm or more and 120 mm or less, and a thickness of 150 μm or more and 250 μm or less was produced.

### (Production of All-Solid-State Battery)

The rectangular electrode laminates produced as described above were stacked to produce a rectangular parallelepiped all-solid-state battery cell.

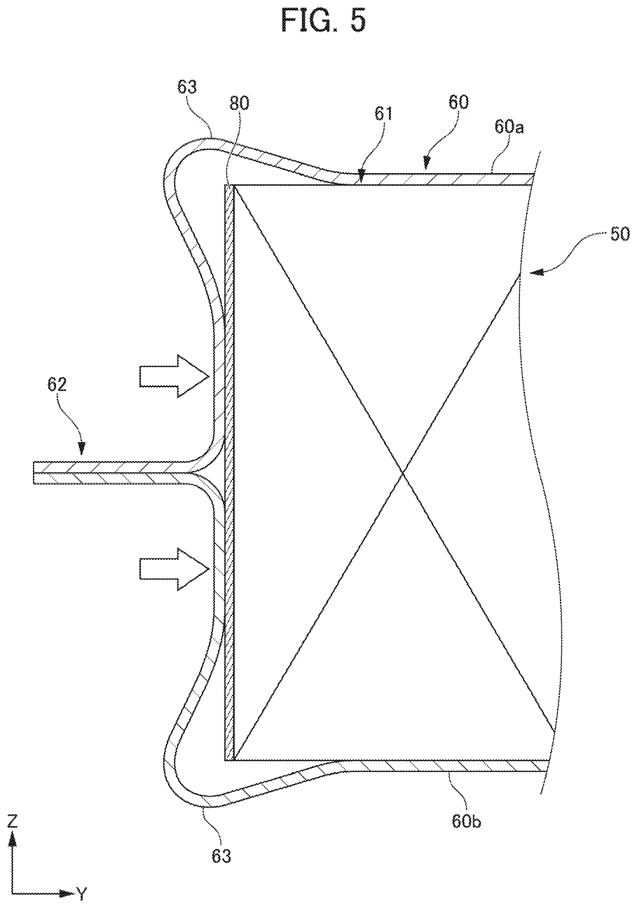

Two laminate films (first laminate film and second laminate film) each having a three-layer structure including an inner resin layer (polypropylene layer, thickness: 23 μm), an aluminum layer (thickness: 80 μm), and an outer resin layer (polyethylene terephthalate layer, thickness: 6 μm) were prepared. The all-solid-state battery cell was disposed on the inner resin of the first laminate film, and the second laminate film was placed thereon so that the inner resin of the second laminate film was disposed on the lower side of the second laminate film. As shown in FIG. 5, a pressure-sensitive sheet 80 was disposed on the long-side side surface of the rectangular parallelepiped solid-state battery cell 50. Next, the end portions of the first laminate film and the second laminate film were overlapped with each other, and three sides of the four sides of the first laminate film and three sides of the four sides of the second laminate film, which respectively oppose each other, were joined by fusion bonding of the inner resins, so that an outer container having an opening in which one side opposite to the side on which the pressure-sensitive paper 80 was disposed was opened was produced.

The outer container was placed in a reduced-pressure chamber, and the internal pressure of the outer container was reduced to degas the interior thereof until the internal pressure thereof reached 20 kPa. When the internal pressure of the outer container reached 20 kPa, the opening was sealed by fusion bonding. Thus, an all-solid-state battery was produced.

### Comparative Example 1

An all-solid-state battery was produced in the same manner as in Example 1 except that the internal pressure of the outer container was reduced to degas the interior thereof until the internal pressure thereof reached 2 kPa.

### Comparative Example 2

An all-solid-state battery was produced in the same manner as in Example 1 except that the internal pressure of the outer container was reduced to degas the interior thereof until the internal pressure thereof reached 80 kPa.

### [Evaluation]

The all-solid-state batteries produced in Example 1 and Comparative Examples 1 and 2 were subjected to a surface pressure test and a vacuum suction test as follows. The results are shown in Table 1 below.

### (Surface Pressure Test)

The all-solid-state battery was allowed to stand for 5 minutes, and then the laminate films were opened, the pressure-sensitive paper 80 disposed on the long-side side surface was removed, and the pressure-sensitive paper was visually observed to confirm the surface pressure and of the pressure applied to the pressure-sensitive paper. The results are shown in Table 1.

### (Occurrence of Wrinkles)

The presence or absence of wrinkles on the upper surface of the all-solid-state battery was visually observed. The results are shown in Table 1.

TABLE 1

| | Surface Pressure Test | Vacuum Suction Test |
|---|---|---|
| Example 1 | Color change occurred due to | No wrinkles occurred on |
| | weak surface pressure | suction surface |
| Comparative | Color change occurred due to | No wrinkles occurred on |
| Example 1 | local high surface pressure | entire surface |
| Comparative | Color change occurred due to | Many wrinkles occurred on |
| Example 2 | slight surface pressure | suction surface |

As shown in Table 1, in the all-solid-state battery of Example 1 in which the internal pressure of the outer casing was within the range of the present invention, color change due to local high surface pressure was not observed in the surface pressure test, and relaxation of the load to the end portion of the electrode laminate was confirmed. Additionally, in the all-solid-state battery of Example 1, it was confirmed that conveyance by suction conveyance was possible because no wrinkles that would hinder suction attachment were observed on the suction surface after reduced pressure degassing.

In contrast, it was confirmed that in the all-solid-state battery of Comparative Example 1 in which the internal pressure of the outer casing was lower than the range of the present invention, there was color change due to local high surface pressure in the surface pressure test, and an excessive load was generated on the end portion of the electrode laminate. It was confirmed that the all-solid-state battery of Comparative Example 2 in which the internal pressure of the outer casing was higher than the range of the present invention was not suitable for conveyance by suction conveyance because many wrinkles were observed on the suction surface after reduced pressure degassing.

### EXPLANATION OF REFERENCE NUMERALS

1 all-solid-state battery
10 positive electrode layer
11 positive electrode current collector
11a positive electrode current collector extension portion
12 positive electrode active material layer
15 positive electrode tab
20 negative electrode layer
21 negative electrode current collector
22 negative electrode active material layer
25 negative electrode tab
30 solid electrolyte layer
40 electrode laminate
50 all-solid-battery cell
60 outer casing
60a, 60b laminate film
61 housing portion
62 sealing portion
63 bent portion
70 resin coat
80 pressure-sensitive paper

What is claimed is:

1. An all-solid-state battery comprising:
an outer casing; and an electrode laminate housed inside the outer casing,
the electrode laminate comprising a positive electrode layer, a negative electrode layer, and a solid electrolyte layer disposed between the positive electrode layer and the negative electrode layer, and
the outer casing having an internal pressure within a range of 10 kPa or more and 20 kPa or less.

2. The all-solid-state battery according to claim 1,
wherein the outer casing comprises a laminate film,
wherein the laminate film comprises a metal layer, an inner resin layer disposed on an inner side of the metal layer, and an outer resin layer disposed on an outer side the metal layer, and
wherein the metal layer has a thickness within a range of 2 times or more and 3 times or less a thickness of the inner resin layer.

3. The all-solid-state battery according to claim 1,
wherein a thickness of the negative electrode layer varies due to charging and discharging, and
wherein the outer casing comprises a bent portion that can expand and contract in a stacking direction of the electrode laminate in accordance with a change in the thickness of the negative electrode layer.

4. The all-solid-state battery according to claim 1, wherein two or more of the electrode laminates are stacked inside the outer casing.

5. The all-solid-state battery according to claim 1, wherein a resin coat is provided on at least a part of a surface of the electrode laminate facing the outer casing.

6. A method for manufacturing an all-solid-state battery, the method comprising:
housing an electrode laminate comprising a positive electrode layer, a negative electrode layer, and a solid electrolyte layer disposed between the positive electrode layer and the negative electrode layer, in an outer container having an opening;
reducing an internal pressure of the outer container to degas an interior thereof through the opening thereof until the internal pressure thereof falls within a range of 10 kPa or more and 20 kPa or less; and
sealing the opening thereof to obtain an all-solid-state battery.

7. The method for manufacturing an all-solid-state battery according to claim 6, further comprising conveying the all-solid-state battery to a predetermined position by suction conveyance.
